(19) United States
(12) Patent Application Publication
(10) Pub. No.: US 2024/0147290 A1
(43) Pub. Date: May 2, 2024

(54) SMART INTERNET OF THINGS GATEWAY SYSTEM OF PROGRAMMABLE LOGIC CONTROLLER DEVICES

(71) Applicant: 4STEC Inc., Incheon (KR)

(72) Inventor: SEUNG WON LEE, Incheon (KR)

(21) Appl. No.: 18/064,877

(22) Filed: Dec. 12, 2022

(30) Foreign Application Priority Data
Nov. 2, 2022 (KR) 10-2022-0144631

(51) Int. Cl. H04W 28/02

(52) U.S. Cl. CPC H04W 28/0215

(57) ABSTRACT

Provided is a smart IoT gateway system for PLC devices, the system including: a PLC comprising a plurality of the PLC devices and lines; IoT sensor hardware configured to acquire IoT data from a plurality of IoT sensors; a smart monitoring device; and an IoT middleware server configured to receive data from the PLC or the IoT sensor hardware, translate the received data to determine state information of a particular PLC device among the PLC devices, a particular line among the lines, or a particular IoT sensor among the IoT sensors, transmit a control command to the PLC or the IoT sensor hardware so that the particular PLC device, the particular line, or the particular IoT sensor is controlled in connection with the state information, and transmit the state information to the smart monitoring device and perform control such that the smart monitoring device displays the state information.

### CROSS REFERENCE TO RELATED APPLICATION

The present application claims priority to Korean Patent Application No. 10-2022-0144631, filed on Nov. 2, 2022, the entire contents of which are incorporated herein for all purposes by this reference.

### BACKGROUND OF THE INVENTION

### Field of the Invention

The present disclosure relates to an Internet-of-Things (IoT) gateway system for programmable logic controller (PLC) devices. More particularly, the present disclosure relates to a gateway system for managing different PLC devices in an integrated manner.

### Description of the Related Art

Recently, in order to build a smart factory, a cyber physical system (CPS) industry technology, PLC devices, and a technology of smart devices, which are communication devices for connecting the PLC devices, have spread. In the meantime, PLC devices are managed in program languages individually set for the respective PLC devices. In order to manage a plurality of PLC devices, interpretation of a plurality of program languages and integrated management are required.

In the meantime, in a conventional method of managing PLC devices, there is no system for communicating with smart devices to manage a plurality of PLC devices in an integrated manner, so costs and time for maintaining and managing a smart factory increase and it may be difficult to link the smart devices and the PLC devices. In particular, in a case in which PLCs of different manufacturers are installed in one manufacturing site, the PLCs of the different manufacturers use different languages and methods of interpreting monitoring results, so it is difficult to perform integrated management of each PLC and the smart devices linked thereto.

In addition, communication between a plurality of different PLC devices and smart devices linked to each PLC is essential in a smart factory, so it may be inconvenient to install and customize an operating program for each device separately.

The foregoing is intended merely to aid in the understanding of the background of the present disclosure, and is not intended to mean that the present disclosure falls within the purview of the related art that is already known to those skilled in the art.

### SUMMARY OF THE INVENTION

Accordingly, the present disclosure is intended to build a gateway of a smart factory so that the gateway performs distributed control on PLC devices efficiently through various networks (e.g., automation network, Fieldbus, or industrial Ethernet).

In addition, the present disclosure enables combination of data of physical assets and software using Internet of Things through the CPS to generate data of PLC devices at a manufacturing site, and uses the generated data for an artificial intelligence technology so that PLC devices are autonomously and actively designed and the operation of a smart factory is optimized.

In addition, the present disclosure is directed to providing a smart IoT gateway system for integrated interpretation and management by translating data of smart devices received from a plurality of different PLCs.

According to an embodiment of the present disclosure, there is provided a smart IoT gateway system for PLC devices, the smart IoT gateway system including: a PLC including a plurality of the PLC devices and lines; IoT sensor hardware configured to acquire IoT data from a plurality of IoT sensors; a smart monitoring device; and an IoT middleware server configured to receive data from the PLC or the IoT sensor hardware, translate the received data to determine state information of a particular PLC device among the PLC devices, a particular line among the lines, or a particular IoT sensor among the IoT sensors, transmit a control command to the PLC or the IoT sensor hardware so that the particular PLC device, line, or IoT sensor is controlled in connection with the state information, and transmit the state information to the smart monitoring device and perform control such that the smart monitoring device displays the state information.

In addition, according to an embodiment of the present disclosure, there is provided an operation method of an IoT middleware server in a smart IoT gateway system, the operation method including: receiving data from a PLC including a plurality of PLC devices and lines or from IoT sensor hardware configured to acquire IoT data from a plurality of IoT sensors; translating the received data to determine state information of a particular PLC device among the PLC devices, a particular line among the lines, or a particular IoT sensor among the IoT sensors; transmitting a control command to the PLC or the IoT sensor hardware so that the particular PLC device, line, or IoT sensor is controlled in connection with the state information; and transmitting the state information to a smart monitoring device and performing control such that the smart monitoring device displays the state information.

In the smart IoT gateway system for PLC devices according to the present disclosure, considering PLC data or a communication state of the PLC, the PLC data or IoT data is processed depending on various management programs or various communication environments, thereby managing PLC devices efficiently. In addition, according to the present disclosure, machine languages of PLC devices are translated according to various types of environment information, so that the accuracy of machine language translation can be improved.

Effects of the present disclosure are not limited thereto, and various effects will be described in detail below with reference to each embodiment.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram illustrating a configuration of a smart IoT gateway system according to an embodiment of the present disclosure;

FIG. 2 is a diagram illustrating an operation of managing a PLC in a smart IoT gateway system according to an embodiment of the present disclosure;

FIG. 3 is a diagram illustrating an operation of advancing an PLC in a smart IoT gateway system according to an embodiment of the present disclosure; and

FIG. 4 is a flowchart illustrating the operation of an IoT middleware server in a smart IoT gateway system according to an embodiment of the present disclosure.

### DETAILED DESCRIPTION OF THE INVENTION

The present disclosure may be modified in various ways and implemented by various embodiments, so specific embodiments are shown in the drawings and will be described in detail. However, it is to be understood that the present disclosure is not limited to the specific exemplary embodiments, but includes all modifications, equivalents, and substitutions included in the spirit and the scope of the present disclosure.

Terms used in the specification, “first”, “second”, “A”, “B”, etc. can be used to describe various elements, but the elements are not to be construed as being limited to the terms. These terms are only used to distinguish one element from another. For example, the “first” element may be named the “second” element without departing from the scope of the present disclosure, and the “second” element may also be similarly named the “first” element. The term “and/or” includes a combination of a plurality of items or any one of a plurality of terms. For example, “A and/or B” may be interpreted as meaning “either A or B or both”. In addition, “/” may be interpreted as “and” or “or”.

As used herein, the singular foils “a,” “an” and “the” are intended to include the plural forms as well, unless the context clearly indicates otherwise. It is to be understood that the teams “comprise”, or the like specify the presence of stated features, numbers, steps, operations, elements, components or combinations thereof, but do not preclude the presence or addition of one or more other features, numbers, steps, operations, elements, components, or combinations thereof.

Prior to a detailed description of the drawings, it is to be clarified that components are just classified for each main function which each component takes charge of. That is, two or more components to be described below may be provided to be combined into one component or one component may be provided to be separated into two or more for each of more subdivided functions. In addition, each of the components to be described below may additionally perform some or all of functions which other components take charge of in addition to the main function which each component takes charge of, and some of the main functions which each component takes charge of may be exclusively performed by other components.

In addition, in carrying out a method or an operation method, the steps of the method may occur in an order different from an order described herein unless a specific order is clearly stated in context. In other words, the steps of the method may be performed in the same order as described, may be performed at substantially the same time, or may be performed in reverse order.

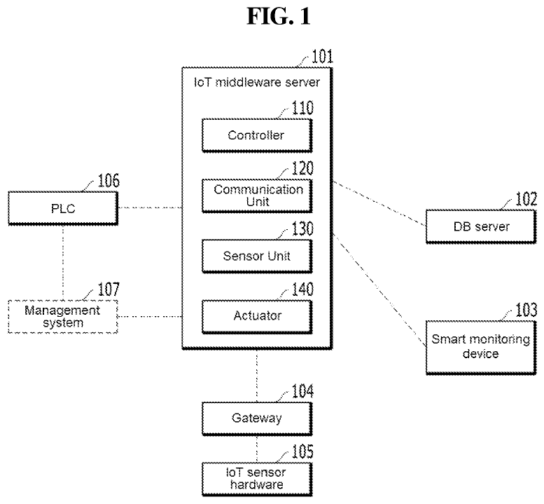

FIG. 1 is a block diagram illustrating a configuration of a smart IoT gateway system according to an embodiment of the present disclosure.

Referring to FIG. 1, the smart IoT gateway system may include an IoT middleware server 101, a DB server 102, a smart monitoring device 103, a gateway 104, IoT sensor hardware 105, a PLC 106, or a management system 107.

According to an embodiment of the present disclosure, the IoT middleware server 101 is a PLC integrated-management device that uses IoT middleware software to manage different PLC devices in an integrated manner.

According to an embodiment of the present disclosure, the PLC 106 may include different kinds of PLC devices. The PLC devices may use different languages (for example, English, Korean) or may be manufactured by different companies (e.g., Siemens, GM), and may be of different types (e.g., integrated, small-sized, block, module, or safety type).

According to an embodiment of the present disclosure, different types of PLCs may convert data received from a smart device (IoT device) into different result values. Herein, the different result values may be data expression methods, for example, arrays of letters or numbers, or various combinations of letters and numbers.

Hereinafter, a case in which a first PLC and a second PLC that are different types of PLCs are operated in one smart factory will be described as an example. It is assumed that temperature sensors described below are installed to monitor the conditions of the same process.

For example, the first PLC receiving data from a first manufacturing line of the smart factory may express a first measurement value received from a temperature sensor installed in the first manufacturing line in a first machine language. Herein, the first PLC may determine whether the measurement value is a value within a preset first valid range of the first PLC.

As another example, the second PLC receiving data from a second manufacturing line of the smart factory may express a second measurement value received from a temperature sensor installed in the second manufacturing line in a second machine language. Herein, the second PLC may determine whether the measurement value is a value within a preset second valid range of the second PLC.

According to an embodiment of the present disclosure, the smart IoT gateway system may translate the first measurement value expressed in the first machine language and may compare the first measurement value with the second measurement value expressed in the second machine language. Alternatively, the smart IoT gateway system may translate the second measurement value expressed in the second machine language and may compare the second measurement value with the first measurement value expressed in the first machine language. According to another embodiment of the present disclosure, the measurement values may be compared by translating the first machine language and the second machine language into a third machine language that is a reference language of the IoT middleware server 101.

Through the machine language translation as described above, the smart IoT gateway system may compare the first valid range with the second valid range, and a third valid range applicable to different PLCs in common may be generated on the basis of the first valid range and the second valid range.

According to an embodiment of the present disclosure, the IoT middleware server 101 may include a controller 110, a communication unit 120, a sensor unit 130, and an actuator 140 as server elements.

According to an embodiment of the present disclosure, the controller 110 may control the overall operation of the IoT middleware server 101. For example, the controller 110 may collect IoT data and sensor data received through the communication unit 120, and may perform functions of communication security encoding/decoding for collected data, connection between IoT/PLC devices, IoT security, events, monitoring and management, IoT monitoring and management, IoT device proxy, system resource protection, system monitoring and management, and Internet protocol management.

According to an embodiment of the present disclosure, the controller 110 may determine sensor data and control data received from the IoT sensor hardware 105 and the PLC 106, and may convert the same into data for controlling the PLC 106.

According to an embodiment of the present disclosure, the controller 110 may check, on the basis of received data, an automation progress between the devices of the PLC 106, devices (or equipment), address information, or line state information, and may check a language being used and information on a PLC management system for each manufacturer or device.

According to an embodiment of the present disclosure, the controller 110 may learn line state information, may determine a replacement period, a replacement point in time, or a current value regarded as normal, and may check that a problem has occurred in a line that deviates from the determined replacement period or point in time or is equal to or greater than the determined current value. Afterward, the controller 110 may transmit information on the checked line and state information of the line to the PLC 106 so that the PLC 106 can solve the problem with the line.

According to an embodiment of the present disclosure, the controller 110 may perform deep learning (e.g., long short-term memory (LSTM)) analysis on data received from the PLC 106 and the IoT sensor hardware 105, and may advance a PLC equipment data analysis and linkage interface for managing the PLC 106 according to a result of the analysis. In addition, the controller 110 may perform deep learning analysis to predict the occurrence of a problem with the PLC 106, and may advance a stream data anomaly detection interface for transmitting a control command for solving the problem to the PLC 106.

According to an embodiment of the present disclosure, a data warehouse may use LSTM to learn long-team dependency on the PLC equipment data analysis and linkage interface and the stream data anomaly detection interface. For example, the data warehouse may connect all recurrent neural networks to have neural network modules repeated in the form of a chain, and may enable a particular neural network module to interact with other neural network modules.

According to an embodiment of the present disclosure, the controller 110 may include the data warehouse to perform deep learning. The data warehouse may perform time series processing, decision-making training data (decision tree) processing, and prediction model storage/loading to determine a problem with the PLC 106.

According to an embodiment of the present disclosure, regarding the time series processing, the data warehouse may perform time series classification as preprocessing, may perform deep learning using LSTM technology, and may perform recurrent neural networks (RNNs). For example, the RNNs form a network with a loop inside the recurrent neural networks, and may receive an input value and an output value in a particular neural network A, and may transmit the output value to another neural network B or another step.

According to an embodiment of the present disclosure, regarding the decision-making training data processing, the data warehouse may perform ensemble learning (random forest) to form categorical decision trees or decision trees composed of features, and may perform classification of the formed decision trees.

According to an embodiment of the present disclosure, the data warehouse may perform prediction model storage/loading to store the formed decision trees as a prediction model for the PLC 106, and may load a particular decision tree into the controller 110 according to a device characteristic of each PLC.

According to an embodiment of the present disclosure, the controller 110 may control the data warehouse to build the PLC equipment data analysis and linkage interface. For example, through the PLC equipment data analysis and linkage interface, the data warehouse may determine a circuit state of the PLC 106 and the IoT sensor hardware 105 on the basis of a signal from an input circuit of the PLC devices included in the PLC 106 and the IoT sensor hardware 105.

According to an embodiment of the present disclosure, the controller 110 may use the data warehouse to determine, according to a circuit form at each circuit location in the PLC 106 and the IoT sensor hardware 105 and an output value according to an on/off state of a switch at the circuit, whether there is an abnormality at the circuit location.

According to an embodiment of the present disclosure, the controller 110 may control the data warehouse to build a PLC data interpretation interface. For example, the data warehouse may determine a circuit state in the PLC 106 and the IoT sensor hardware 105 on the basis of a signal from an input circuit of the PLC devices included in the PLC 106 and the IoT sensor hardware 105.

According to an embodiment of the present disclosure, the controller 110 may use the PLC data interpretation interface to check information received from the PLC devices and determine whether a replacement period has come to a particular line among the PLC devices. For example, the controller 110 may transmit a signal indicating arrival of a replacement period of a particular line to the PLC 106 so that the PLC 106 may check replacement information on the line.

According to an embodiment of the present disclosure, the controller 110 may use the PLC data interpretation interface to translate machine languages received from the PLC devices included in the PLC 106 and the IoT sensor hardware 105. For example, although a replacement period of a particular line among the PLC devices has not come, the controller 110 may reset the replacement period of the line on the further basis of a signal received by the IoT sensor hardware 105. For example, according to environment information (e.g., temperature, humidity, pressure, etc.) included in a signal received by the IoT sensor hardware 105, the controller 110 may reset the replacement period of the line to a period (e.g., one month) shorter than a set value (e.g., three months). As the reset period has come, the controller 110 may transmit a signal indicating arrival of the replacement period of the line to the PLC 106.

According to an embodiment of the present disclosure, the controller 110 may use the PLC data interpretation interface to check a machine language received from each of the PLC devices of the PLC 106 and a translation result of the machine language. Afterward, re-integration and storage may be performed in the PLC data interpretation interface. For example, the controller 110 may integrate machine languages of which machine language translation results are similar.

According to an embodiment of the present disclosure, when the IoT middleware server 101 receives a first machine language from a PLC of company A, the IoT middleware server 101 may transmit the received first machine language to the controller 110. For example, the controller 110 may check a translation result corresponding to the first machine language among the integrated machine language translation results and may transmit the translation result to the PLC.

In addition, according to an embodiment of the present disclosure, a particular PLC may receive a machine language in a language not supported or a machine language of a PLC of another company. Herein, the particular PLC may transmit the received machine language to the IoT middleware server 101 through the PLC 106. For example, the controller 110 of the IoT middleware server 101 may check a translation result corresponding to the received machine language among the integrated machine language translation results and may transmit the translation result to the particular PLC.

According to an embodiment of the present disclosure, even when a particular PLC receives a machine language in a language different from a language used in the particular PLC or receives a machine language of a PLC of another company, the particular PLC transmits the same to the IoT middleware server 101. Accordingly, the particular PLC may receive a machine language translation result of inputting the different language or the machine language of the company.

According to an embodiment of the present disclosure, the controller 110 may transmit the machine language translation result to the PLC, and may receive a feedback on the machine language translation result from the PLC. For example, a machine language generated in a particular PLC is translated as “replace line B within three mounts”, but afterward, the PLC may process a machine language “replace line B within one month” under the control of a manager. The PLC may transmit information on the processed machine language to the IoT middleware server 101.

According to an embodiment of the present disclosure, the IoT middleware server 101 may define a new machine language based on the processed machine language and a pre-stored machine language translation result. For example, the IoT middleware server 101 may update the stored machine language translation result with the defined new machine language.

According to an embodiment of the present disclosure, the controller 110 may store environment information, a translation result of a machine language, and information on a signal transmitted accordingly in the DB server 102 as information on a reset line. Afterward, the controller 110 may translate, on the basis of the information stored in the DB server 102, a signal received from the PLC 106.

According to an embodiment of the present disclosure, the communication unit 120 may use a predetermined network communication environment to transmit and receive data to and from devices of the smart IoT gateway system. For example, the data may include sensor data of the PLC devices received from the PLC 106 and IoT data received from the IoT sensor hardware 105. The network communication environment may include Wireless Fidelity (Wi-Fi), long-term evolution (LTE), narrowband (NB)-IoT, long range (LoRa) radio, or 5G.

According to an embodiment of the present disclosure, the communication unit 120 may perform network communication with the PLC devices and the IoT sensor hardware 105 according to a communication environment determined by the controller 110. For example, the controller 110 may determine a state of a communication environment of each of the PLC devices or the IoT sensor hardware 105 and communication areas of the devices, thereby determining a network communication method.

According to an embodiment of the present disclosure, the controller 110 may monitor a communication state of the communication unit 120 in real time, and may change the network communication environment according to the communication state. For example, when it is determined that a communication state of the communication unit 120 is lower power or lower signal strength than a pre-specified value, the controller 110 may determine a corresponding communication area as a shadow area. Afterward, the controller 110 may change the network communication environment into NB-IoT or LoRa and may control the communication unit 120 so that communication is performed.

According to an embodiment of the present disclosure, the sensor unit 130 may convert sensor data received from the PLC 106 into data that the IoT middleware server 101 can process. For example, the sensor data may be received from the PLC 106 and may be acquired from sensors with which the plurality of PLC devices included in the PLC 106 are provided.

According to an embodiment of the present disclosure, the sensor unit 130 may use received sensor data to determine a PLC device among the plurality of PLC devices that has transmitted the sensor data. In addition, the sensor unit 130 may transmit the sensor data to the controller 110, and the controller 110 may analyze the sensor data to determine whether a problem has occurred in the PLC device.

According to an embodiment of the present disclosure, the actuator 140 may include a mechanical device for moving or controlling the IoT middleware server 101.

According to an embodiment of the present disclosure, the DB server 102 may store a learning model for learning and solving problems related to processes in the smart factory and the PLC 106. In addition, the DB server 102 may store a machine language of the PLC 106 and a translation result thereof received from the IoT middleware server 101.

According to an embodiment of the present disclosure, the DB server 102 may transmit the stored information to the middleware server 101 as the middleware server 101 makes a request. For example, the middleware server 101 may translate a machine language of the PLC 106 in various situations according to the information received from the DB server 102 and may provide information for determining and solving problems related to processes of the PLC 106.

According to an embodiment of the present disclosure, the smart monitoring device 103 is a device for outputting monitoring results for the PLC 106 in various types of data (e.g., image data or voice data), and may be a smartphone, a laptop computer, a tablet PC, or the like.

According to an embodiment of the present disclosure, the gateway 104 may relay data communication between the IoT middleware server 101 and the IoT sensor hardware 105.

According to an embodiment of the present disclosure, the IoT sensor hardware 105 is an IoT sensor or device that is connected and communicates with the PLC 106, and may be an RFID device, a Bluetooth device, a GPS device, a temperature/humidity/motion/weight sensor, a vehicle number recognition device, a camera, a wearable device, or a smart device control device. For example, the IoT sensor hardware 105 may transmit data generated from the IoT sensor or device to the IoT middleware server 101 through the gateway 104.

According to an embodiment of the present disclosure, the PLC 106 may include the plurality of PLC devices and lines connecting the plurality of PLC devices, and may store automation progress information, device (or equipment) information, address information, line state information, or PLC management program information for each PLC device/line. For example, the automation progress information may include logic information for identifying and solving problems with respect to various situations occurring in a sequence between processes, conditions for performing the processes, or an automation progress. The address information may indicate locations of the PLC devices and the lines included in the PLC 106. The line state information may include information related to the lines, for example, a replacement period, a replacement point in time, a current value of a particular line, etc.

According to an embodiment of the present disclosure, the management system 107 may store a program, such as an enterprise resource planning (ERP) program, a supply chain management (SCM) program, a manufacturing execution system (MES) program, etc., and other various management systems for managing the PLC 106 may be possible.

In addition, the PLC 106 is connected to the management system 107 so that the PLC devices of the PLC 106 may be controlled by the management system 107. In the meantime, when the PLC 106 performs control and communication functions of the PLC devices as the PLC devices themselves are, the management system 107 may be omitted in the smart IoT gateway system.

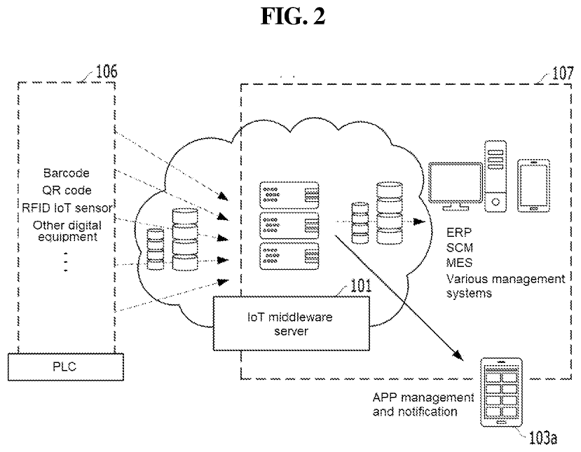

FIG. 2 is a diagram illustrating an operation of managing a PLC in a smart IoT gateway system according to an embodiment of the present disclosure.

Referring to FIG. 2, the smart IoT gateway system may include an IoT middleware server 101, a smart monitoring device 103a, a PLC 106, and a management system 107.

According to an embodiment of the present disclosure, the IoT middleware server 101 may check information received by the PLC 106 from various digital devices or sensors (e.g., a barcode, a QR code, RFID, and an IoT sensor) connected to the PLC 106, and may transmit the information to the smart monitoring device 103a or the management system 107.

According to another embodiment of the present disclosure, the IoT middleware server 101 may transmit the information received by the PLC 106 to the management system 107 so that information on a particular PLC device is processed by a program (e.g., ERP, SCM, or MES) of the management system 107 set for each PLC device.

According to another embodiment of the present disclosure, the IoT middleware server 101 may transmit, on the basis of the information received by the PLC 106, data for application management and notification to the smart monitoring device (e.g., a smartphone 103a). For example, the IoT middleware server 101 may transmit data for the smartphone 103a to manage a particular PLC device or line and check state information, and may transmit a notification including information to notify when a problem has occurred in the particular PLC device or a replacement period of the particular line has come.

According to another embodiment of the present disclosure, an application for managing the PLC 106 and receiving a notification may be installed on the smartphone 103a. The application may display state information of the PLC devices and lines included in the PLC 106 in real time, and may provide an interface for controlling a particular PLC device and line. In addition, the application may receive a notification from the IoT middleware server 101 as a push message, and may display information on the occurrence of a problem with a PLC device or a replacement period of a line included in the push message.

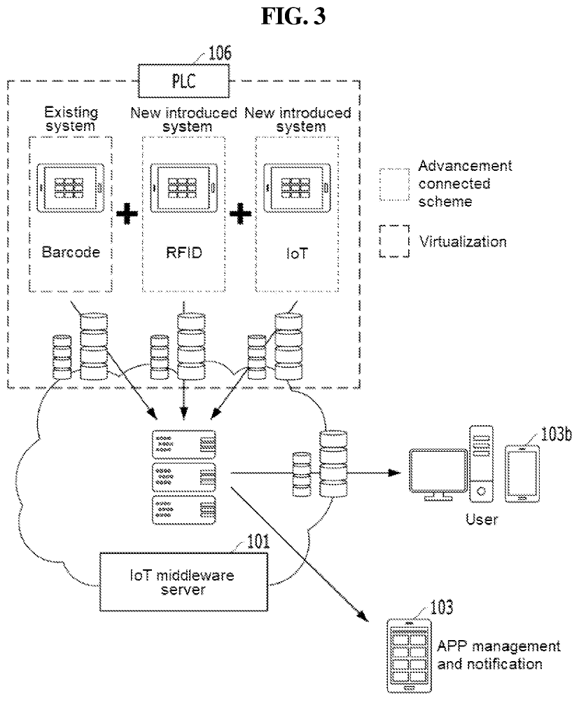

FIG. 3 is a diagram illustrating an operation of advancing an PLC in a smart IoT gateway system according to an embodiment of the present disclosure.

Referring to FIG. 3, the smart IoT gateway system may include an IoT middleware server 101, a smart monitoring device 103b, and a PLC 106.

According to an embodiment of the present disclosure, when a new system (e.g., RFID or IoT) is introduced into the PLC 106, the IoT middleware server 101 may perform advance and virtualization for integration with an existing system (e.g., barcode). For example, the advance may convert information in an existing system and a new introduced system into data that another system can process.

According to an embodiment of the present disclosure, the IoT middleware server 101 may perform virtualization on an existing system and new introduced systems. For example, while the existing system for obtaining information by scanning barcode information attached to the PLC devices or lines is built in the PLC 106, the new introduced systems (e.g., RFID or IoT) may be added. Afterward, the PLC 106 may process information (e.g., barcode data, RFID data, or IoT data) in the existing system and the new introduced systems into a form of data used in a particular system or a new form.

According to an embodiment of the present disclosure, the IoT middleware server 101 may transmit data subjected to virtualization to various smart monitoring devices 103 (or a user terminal 103b). For example, in a case in which a problem has occurred in a particular PLC device with various systems coexisting in the PLC 106, even though the IoT middleware server 101 receives data of the particular PLC device through the existing system, the IoT middleware server 101 may convert the data of the particular PLC device into data of a new introduced system, may translate the data of the new introduced system, and may transmit a translation result to a related device (e.g., the smart monitoring device 103). In addition, when the IoT middleware server 101 receives the data of the PLC device through a new introduced system, the IoT middleware server 101 may convert the data of the PLC device into data of a pre-specified form, may translate the data of the pre-specified form, and may transmit a translation result to a related device (e.g., the user terminal 103b).

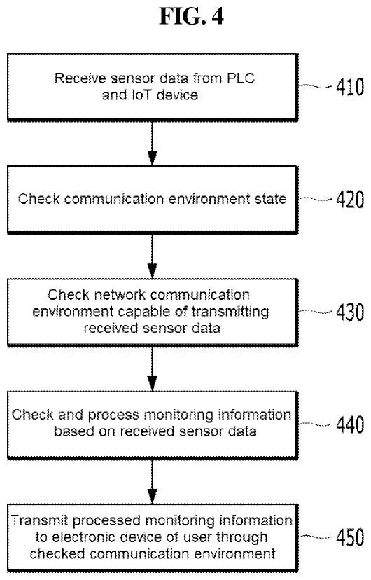

FIG. 4 is a flowchart illustrating the operation of an IoT middleware server in a smart IoT gateway system according to an embodiment of the present disclosure.

Referring to FIG. 4, the IoT middleware server 101 may receive sensor data from a PLC 106 and an IoT device (e.g., IoT sensor hardware 105) in step S410.

In step S420, the IoT middleware server 101 may check a state of a communication environment. For example, the communication environment may include Wi-Fi, LTE, NB-IoT, LoRa, or 5G, and other various short-range or cellular wireless communication environments may be possible.

According to an embodiment of the present disclosure, elements of the smart IoT gateway system may be connected through various communication environments. For example, the IoT middleware server 101 may collect IoT sensor data from the IoT sensor hardware 105 in real time through a communication environment, and may use the collected data to monitor a communication environment state of the smart IoT gateway system.

In step S430, the IoT middleware server 101 may check, on the basis of the communication environment state, a network communication environment capable of transmitting the received sensor data.

According to an embodiment of the present disclosure, the IoT middleware server 101 may use an NB-IoT or LoRa communication environment to transmit the data collected in the smart IoT gateway system. For example, as a result of checking the communication environment state, when it is determined that a particular area is a shadow area in which communication is performed with power or signal strength lower than a reference value, the IoT middleware server 101 may perform communication in the shadow area through the NB-IoT or the LoRa communication environment.

In step S440, the IoT middleware server 101 may check monitoring information based on the received sensor data, and may process the checked information into a form that can be output from the smart monitoring device 103 or an electronic device of a user.

In step S450, the IoT middleware server 101 may transmit the processed monitoring information to the electronic device (e.g., the smart monitoring device 103) of the user through the checked communication environment.

Exemplary embodiments of the present disclosure may be implemented by various means, for example, hardware, firmware, software, or a combination thereof. In the case of implementation by hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, micro controllers, micro processors, etc.

In addition, in the case of implementation by firmware or software, an embodiment of the present disclosure may be implemented by modules, procedures, and/or functions for performing the above-described functions or operations, and may be recorded on a recording medium readable through various computer means. Herein, the recording medium may include program instructions, data files, and/or data structures either alone or in combination. The program instructions to be recorded on the recording medium may be specially designed and configured for the present disclosure or may be well-known to and be usable by those skilled in the art of computer software. Examples of the recording medium include magnetic media such as hard disks, floppy disks, and magnetic tapes; optical media such as compact disk read-only memories (CD-ROM) and digital video disks (DVDs); magneto-optical media such as floptical disks; and hardware devices, such as ROM, RAM, flash memory, etc., which are specially configured to store and execute program instructions. Examples of the program instructions may include not only a mechanical language code formatted by a compiler but also a high level language code that may be implemented by a computer using an interpreter, etc. The hardware devices may be configured to be operated as one or more software modules to conduct the operation according to the present disclosure, and vice versa.

In addition, a device or terminal according to the present disclosure may be run by a command for one or more processors to execute the above-described functions and processes. Examples of the command may include an interpreted command, such as a script command, e.g., a JavaScript or ECMAScript command, or executable code, or other commands stored in a computer readable medium. Furthermore, a device according to the present disclosure may be implemented in a distributed manner over a network like a server farm, or may be implemented in a single computer device.

In addition, a computer program (also known as a program, software, software application, script, or code) installed on a device according to the present disclosure and executing a method according to the present disclosure may be written in any form of a programming language that includes compiled or interpreted languages or declarative or procedural languages, and may be deployed in any form including a stand-alone program or module, a component, a subroutine, or another unit suitable for use in a computing environment. A computer program does not necessarily correspond to a file of a file system. A program may be stored in a single file provided to the requested program, in multiple coordinated files (for example, files that store one or more modules, sub-programs, or portions of code), or in a portion of a file (for example, one or more scripts stored in a markup language document) that holds other programs or data. A computer program may be deployed to be executed on one computer or multiple computers that are located at one site or distributed across multiple sites and interconnected by a communication network.

Although the present disclosure has been described with reference to separate drawings for the convenience of description, a new embodiment may be implemented by combining embodiments illustrated in the respective drawings. In addition, the configurations and methods of the above-described embodiments of the present disclosure may not be applied in a limited manner, and all or part of each of the above-described embodiments may be selectively combined and configured to make a variety of modifications.

Although the exemplary embodiments of the present disclosure have been illustrated and described above, the present disclosure is not limited to the aforesaid particular embodiments, and can be variously modified by those skilled in the art without departing the gist of the present disclosure defined in the claims. The modifications should not be understood individually from the technical idea or perspective of the present disclosure.

What is claimed is:

1. A smart IoT gateway system for PLC devices, the smart IoT gateway system comprising:
a PLC comprising a plurality of the PLC devices and lines;
IoT sensor hardware configured to acquire IoT data from a plurality of IoT sensors;
a smart monitoring device; and
an IoT middleware server configured to
receive data from the PLC or the IoT sensor hardware,
translate the received data to determine state information of a particular PLC device among the PLC devices, a particular line among the lines, or a particular IoT sensor among the IoT sensors,
transmit a control command to the PLC or the IoT sensor hardware so that the particular PLC device, the particular line, or the particular IoT sensor is controlled in connection with the state information, and
transmit the state information to the smart monitoring device and perform control such that the smart monitoring device displays the state information.

2. The smart IoT gateway system of claim 1, wherein the IoT middleware server is configured to
check a communication state of the PLC from the state information, and
transmit a control command for changing a network communication environment to the PLC when the communication state indicates low power or signal strength equal to or lower than a pre-specified value.

3. The smart IoT gateway system of claim 2, wherein the network communication environment comprises Wi-Fi, LTE, NB-IoT, LoRa, or 5G.

4. The smart IoT gateway system of claim 1, further comprising a management system configured to store a plurality of management programs therein,
wherein the IoT middleware server is configured to perform control such that data generated from the PLC devices is processed according to the management programs pre-specified for the respective PLC devices in the management system.

5. The smart IoT gateway system of claim 1, wherein the IoT middleware server is configured to, when a machine language is input from the PLC, translate the machine language according to a pre-stored learning model, and transmit a translation result of the machine language to the PLC.

6. The smart IoT gateway system of claim 5, wherein the IoT middleware server is configured to, when environment information is received from the PLC, update the learning model to translate the machine language of the PLC on the further basis of the received environment information.

7. An operation method of an IoT middleware server in a smart IoT gateway system, the operation method comprising:
receiving data from a PLC comprising a plurality of PLC devices and lines or from IoT sensor hardware configured to acquire IoT data from a plurality of IoT sensors;
translating the received data to determine state information of a particular PLC device among the PLC devices, a particular line among the lines, or a particular IoT sensor among the IoT sensors;
transmitting a control command to the PLC or the IoT sensor hardware so that the particular PLC device, the particular line, or the particular IoT sensor is controlled in connection with the state information; and
transmitting the state information to a smart monitoring device and performing control such that the smart monitoring device displays the state information.

8. The operation method of claim 7, further comprising:
checking a communication state of the PLC from the state information; and
transmitting a control command for changing a network communication environment to the PLC when the communication state indicates low power or signal strength equal to or lower than a pre-specified value,
wherein the network communication environment comprises Wi-Fi, LTE, NB-IoT, LoRa, or 5G.

9. The operation method of claim 7, further comprising:
communicating with a management system configured to store a plurality of management programs therein; and
processing data generated from the PLC devices according to the management programs pre-specified for the respective PLC devices in the management system.

10. The operation method of claim 7, further comprising:
translating, when a machine language is input from the PLC, the machine language according to a pre-stored learning model; and
transmitting a translation result of the machine language to the PLC.

11. The operation method of claim 10, further comprising updating, when environment information is received from the PLC, the learning model to translate the machine language of the PLC on the further basis of the received environment information.
